(19) United States
(12) Patent Application Publication
(10) Pub. No.: US 2008/0221909 A1
(43) Pub. Date: Sep. 11, 2008

(54) ANIMATED CONNECTION PAGE

(75) Inventors: Ahti Muhonen, Hirvihaara (FI); Matthew Snyder, Vancouver (CA)

Correspondence Address: BANNER & WITCOFF, LTD., 1100 13th STREET, N.W., SUITE 1200, WASHINGTON, DC, 20005-4051, US

(73) Assignee: Nokia Corporation, ESPOO (FI)

(21) Appl. No.: 11/683,828

(22) Filed: Mar. 8, 2007

(51) Int. Cl. G06F 19/00

(52) U.S. Cl. 705/1

(57) ABSTRACT

A method and device for facilitating interaction with one or more advertisement functionalities is provided. An advertisement middleware component provides advertisement functionalities for interfacing with one or more systems and components of an underlying device. The advertisement middleware component includes a connection page that provides a consistent and trusted user interface for mobile advertisement.

### FIELD OF ART

The invention relates generally to a system for facilitating the distribution and access of electronic information. Specifically, the invention relates to a method for displaying advertising information on a mobile device.

### BACKGROUND

Advertising-supported applications are increasing in popularity as advertisers and companies strive for new ways to reach the public or a specified segment thereof. Advertising-supported application or adware is any software package which automatically plays, displays, or downloads advertising material to a computer after the software is installed on it or while the application is being used. Advertising-supported applications are often small and unobtrusive to attract more users and appear less invasive. Companies often offer greater discounts or special offers through these applications as an incentive to use the advertising applications. Advertising-supported applications have been developed for computing devices such as desktop computers, laptops and even mobile devices, such as Personal Data Assistants (PDAs) and cellular phones.

However, with the ever increasing number of types and brands of computing devices, developers of advertising-supported applications often need to program the applications specifically for each device or architecture. Programming applications for each different type of device or architecture can be time consuming, complex and costly for not only the developers but for the companies funding such ventures. Furthermore, for each supported device the look and feel of the programming application may be vastly different making it confusing for users with multiple devices or users' switching devices. Moreover, current advertising supported applications do not provide users with a listing of appropriate choices for actions related to the displayed advertisement. Typically, the displayed advertisements are overloaded with information which is not user friendly.

In addition, some advertising applications may only exist for certain devices or types of devices, limiting the reach of some advertisements. Further, downloading applications that are not specifically designed for a user's device may cause significant technical issues with the device.

For the foregoing reasons, a method of facilitating access to advertising functionality providing a similar experience for users of different devices is needed.

### SUMMARY

Many of the aforementioned problems are solved by providing middleware for facilitating advertisement functionality. The advertisement middleware provides functionality to interface with hardware and software components associated with a particular device. As such, application developers may not need to cater their programming to a particular device or type of device.

In accordance with an aspect of the invention, the middleware may provide a connection page module that extends to everything on the mobile device. The connection page module may act as an intelligent agent to provide functionality that connects to various content servers. In an embodiment, the connection page module may provide a user interface for mobile advertisement.

In accordance with yet another aspect of the invention, the user interface provided by the connection page module may provide click-to-action functionality. The click-to-action functionality may include functions such as click-to-call, click-to-browse, click-to-save-to gallery, click-to-arts, click-to-save, click-to-send-to-friend, click-to-stream, and various other click-to-do functions.

In accordance with still another aspect of the invention, application middleware may further provide security features. For example, trust may be provided such that spam is significantly reduced or eliminated. Furthermore, privacy breaches may be prevented. With the connection page, secure communications between an application and a content server, for example, may be significantly streamlined.

In yet another aspect of the invention, application middleware may provide for distribution of the connection page module. For example, the middleware may provide for viral distribution such that when the connection page module is available for sharing by one user is may be downloaded by another user who then in turn, makes the connection page available to others.

In an additional aspect of the invention, application middleware may provide a direct one-to-one dialog with an advertiser or marketer through the connection page module. The dialog may include proving additional information regarding the product being advertised per user request.

These as well as other aspects of the invention are apparent and understood from the following detailed description of the invention, the attached claims, and the accompanying drawings.

### BRIEF DESCRIPTION OF THE DRAWINGS

The present invention is illustrated by way of example and not limited in the accompanying figures in which like reference numerals indicate similar elements and in which:

FIG. 1 illustrates a block diagram of a wireless communication system in which various embodiments may be implemented in accordance with an aspect of the invention.

FIG. 2 illustrates a mobile device in which one or more illustrative embodiments may be implemented in accordance with an aspect of the invention.

FIG. 3 is a block diagram illustrating components of an application middleware and interactions with other components in accordance with an aspect of the invention.

FIG. 4 illustrates a block functionality diagram of an advertising middleware in accordance with an aspect of the invention.

FIG. 5 illustrates a flow chart of a method for providing relevant advertisements to a requesting application via a middleware component in accordance with an aspect of the invention.

FIG. 6 illustrates a user interface that may be used in connection with mobile advertisement in accordance with an aspect of the invention.

FIG. 7 illustrates an additional user interface that may be used to interact with an advertiser in accordance with an aspect of the invention.

FIG. 8 illustrates a flow chart of a method for displaying relevant advertisements to a requesting application via a middleware component in accordance with an aspect of the invention.

FIG. 9 illustrates a flow chart of a method for displaying a connection page with advertisement in accordance with an aspect of the invention.

FIG. 10 illustrates another flow chart of a method for displaying a connection page with advertisement in accordance with an aspect of the invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the invention.

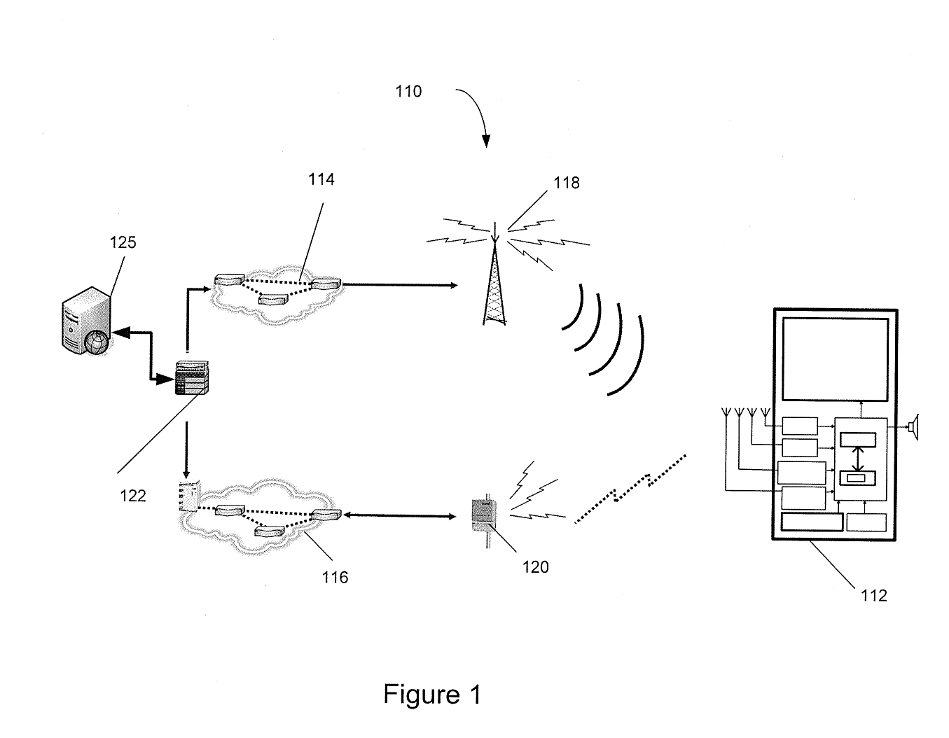

Aspects of the invention may be utilized across a broad array of networks and communication protocols. FIG. 1 illustrates an example of a wireless communication system 110 in which systems and methods according to at least some embodiments may be employed. One or more network-enabled mobile or fixed devices 112, such as a personal digital assistant (PDA), cellular telephone, mobile terminal, personal video recorder, television, set-top box (STB), personal computer, digital camera, digital camcorder, portable audio device, portable radio, location determination device (e.g. a GPS (Global Positioning System) device) or combinations thereof, are in communication with a service source 122 through a broadcast network 114 (which may include the Internet or similar network) and/or a cellular network 116. The mobile terminal/device 112 may include a digital broadband broadcast receiver device. The service source 122 may be connected to several service providers such as advertisement source 125 that may provide their actual program content or information or description of their services and programs to the service source 122 that further provides the content or information to the mobile device 112. The several service providers including advertisement source 125 may include but are not limited to one or more television and/or digital television service providers, AM/FM radio service providers, advertisement servers and/or providers, Short Message System/Multi Media Messages (SMS/MMS) push service providers, Internet content or access providers.

In one or more arrangements, broadcast network 114 may broadcast advertisements from one or more service sources such as service source 122. Service source 122 may obtain or receive advertisements from an advertisement server or provider. The advertisements may then be received by mobile terminal 112 through the broadcast network 114 and stored in a database for display to a user of terminal 112. In one example, a broadcast service source 122 may obtain revenue from displaying advertisements in their broadcasts. As such, the broadcast service source 122 may periodically retrieve advertisements from an advertisement source 125 or database and broadcast the advertisement to a user population subscribed to the broadcast service. One method of broadcasting data is using IP datacasting (IPDC). IPDC combines digital broadcasting and Internet Protocol. As such, a variety of information and services may be transmitted using such a network and protocol.

The mobile device 112 may also send and receive messages to and from the service source 122 through the cellular network 116. The cellular network 116 may include a wireless network and a base transceiver station transmitter 120. The cellular network may include a second/third-generation (2G/3G) cellular data communications network, a Global System for Mobile communications network (GSM), a Universal Mobile Telecommunications System (UMTS) and/or other wireless communication network such as a Wireless Local Area Network (WLAN) network. In one or more aspects, communications through the cellular network 116 may allow a service source 122 to distribute advertisements on an individual basis. That is, rather than broadcasting advertisements to an entire subscriber population, the service source 122 may obtain and distribute advertisements from an advertising source 125 based on user interests, usage statistics, a user's most frequent time of use and the like. Alternatively or additionally, mobile device 112 may access either the broadcast network 114 or cellular network 116 to retrieve advertisements or other forms of content from a server or content provider 122. In one example, device 112 may request additional advertisements from an advertisement server 125 in response to determining that no advertisements are stored in device 112.

In accordance with one aspect of the invention, mobile device 112 may include a wireless interface configured to send and/or receive digital wireless communications within cellular network 116 using base transceiver station transmitter 120. The information received by mobile device 112 through the cellular network 116 or broadcast network 114 via a cellular network tower 118 may include user input or selection (for example, in an interactive transmission), applications, services, electronic images, content requests, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

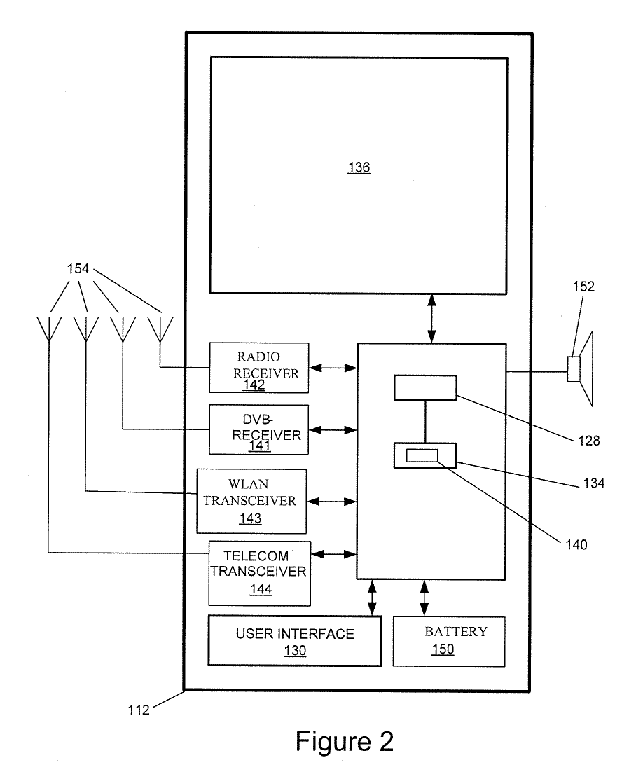

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, four arrow keys, joy-stick, stylus, data glove, mouse, roller ball, touch screen, or the like. In addition, user interface 130 may include the entirety of or portion of display 136.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of the computer executable instructions may be embodied in hardware or firmware (not shown).

Mobile device 112 may be configured to receive, decode and process digital broadband broadcast transmissions that are based, for example, on the Digital Video Broadcast (DVB) standard, such as Digital Video Broadcast-Handheld (DVB-H), Digital Video Broadcast-Terrestrial (DVB-T) or Digital Video Broadcast-Multimedia Home Platform (DVB-MHP), through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other Digital Video Broadcast standards, such as Digital Video Broadcast-Multimedia Home Platform, DVB-Satellite (DVB-S), Digital Video Broadcast-Terrestrial (DVB-T) or Digital Video Broadcast-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in Digital Video Broadcast-Handheld technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation. The power of receiver between bursts may be turned off to reduce power consumption.

In one or more configurations, a user of a mobile device may agree to receive advertisements on his/her mobile device. To facilitate the display of advertisements, a connection page may be used to connect to the applications found in the user's mobile device to an external network. For example, the user's mobile terminal may include an advertisement middleware that provides an application programming interface (API) that allows an application to call standardized functions for retrieving advertisements or performing other advertising tasks.

Middleware, in general, refers to an entity that facilitates interaction between software and/or hardware components. For example, a middleware may perform processes such as mediation between an application and a network to manage the interaction between disparate applications across heterogeneous platforms. Advertisement middleware may provide a variety of functionalities associated with the display and retrieval of advertisements. For example, the middleware in the form of a connection page relieves other applications from having to implement the middleware functionalities. Instead, the other applications may call various functions of the middleware to accomplish various advertisement tasks or processes. Advertisement middleware may be stored in a computer readable medium 134 in a user's mobile terminal 112 along one or more advertisement applications that may interface with the middleware. The advertisement application or widget may display advertisements or other information on display 136. Advertisement middleware may also include components for interfacing with one or more hardware components such as WLAN transceiver 143, telecom transceiver 144 and display 136 to perform one or more tasks.

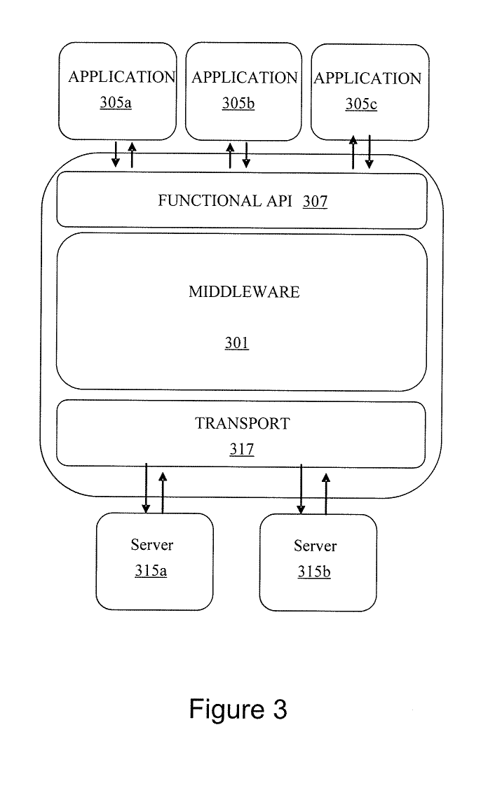

FIG. 3, describing one aspect of the invention, is a block diagram illustrating a middleware component 301. Among other capabilities, middleware component 301 may coordinate communication, data, messages, and user interaction between one or more content servers 315a and 315b and one or more applications 305a, 305b and 305c executing on the mobile terminal device. Middleware component 301 may expose one or more functional APIs, such as API 307, to provide an application 305 with a standardized interface for performing advertisement related functions. The middleware component 301 may also interact with a server 315a or 315b through a transport layer 317 which may include a plurality of transport mechanisms and/or protocols including Hypertext Transfer Protocol (HTTP), File Transfer Protocol (FTP), SMS, Bluetooth, WLAN, Radio Frequency Identification (RFID), RSS, or 2D Barcode. For example, middleware component 301 may determine that there are no advertisements available in the device's storage. As such, middleware 301 may connect to an advertisement server 315a to request additional advertisements. The request may be issued through the transport layer 317 which may provide multiple protocols for making such a request. In general, transport layer 317 may facilitate any communications with external devices or entities.

Alternatively or additionally, middleware component 301 may include or interact with a hardware API to instruct various hardware components to perform certain functions or tasks. The processes and interfaces shown in FIG. 3 are for illustrative purposes, and those of skill in the art will appreciate that middleware component 301 may support additional processes, components and interfaces in addition to those shown.

Further, middleware component 301 exposes one or more APIs to application programs 305a, 305b and 305c executing on the mobile terminal device. Application programs 305a, 305b and 305c may be implemented on a variety of platforms including Symbian and Java 2 Platform Micro Edition (J2ME). Each application program 305a, 305b and 305c may contain predefined programming to facilitate interfacing with the middleware component 301 using the exposed APIs. The functional APIs associated with middleware 301 may be published to the public or a group of developers to allow them to implement the proper programming in applications 305a, 305b and 305c to utilize the functionalities of middleware 301. Thus, applications 305a, 305b and 305c might not need to implement the functionalities already provided by the middleware component 301. For example, applications might not need to include programming to perform functions such as storing user profiles and interfacing with software and hardware subsystems. Using the functionalities of component 301 may include a reduction in load on the overall operating system of the underlying device. The applications 305a, 305b and 305c may be, for example, a web browser, an email, a messaging application, a phone, a location application, a phone book, a contact list, a game, a presentation application, a media player, a music player, a video player, a text editor, etc.

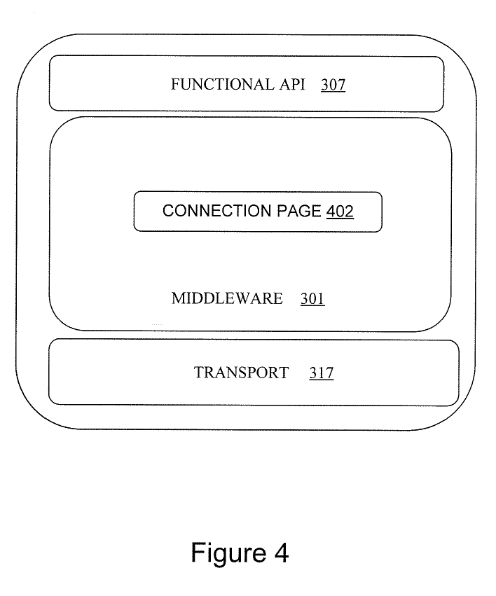

FIG. 4, describing one aspect of the invention, is a block diagram illustrating architecture of a middleware component. Middleware component 301 may include a connection page module 402. In addition, middleware component 301 may interface with a content server (e.g., advertising server) via transport mechanism 317, as well as with the user of the mobile terminal device via one or more end-user interfaces such as keys, buttons, dials, display screens, speakers, etc., of the mobile terminal device.

As described above, functional API 307 may interface with one or more application level programs (not shown). Function calls and requests by the applications through functional API 307 may be routed directly to connection page module 402. Connection page module 402 may initially receive the request or input from the application via the functional API 307 and direct the request to a different applicable module of the middleware component 301. Connection page module 402 may connect to everything located on the mobile device and act as a manger or intelligent agent to other applications.

In an aspect of the invention, connection page module 402 may receive a request from an application via the functional API 307 to display or provide advertisements. In response, the connection page module 402 may extract from the request one or more parameters, such as the type of advertisement to be provided, e.g., full screen, banner, ticker; duration for displaying or playing advertisement; position and/or size of advertisement to be displayed; and interval for refreshing the advertisement or for providing new advertisements. Some parameters may be optional and may be used with pre-defined default values if left unspecified.

Connection page module 402 may subsequently select one or more advertisements in accordance with the parameters from local memory that stores advertisements. Alternatively, the advertisement may be stored in a database (not shown) with retrieval functions to facilitate the selection of advertisements based upon the parameters. If the local memory is empty or does not contain any advertisements fitting the parameters requested by the application, connection page module 402 may retrieve one or more advertisements from a server (e.g., server 315a of FIG. 3) via a transport mechanism 317 in accordance with the parameters specified in the initial request.

Connection page module 402 may be implemented in software via computer executable instructions stored in a memory, or via hardware, e.g., as one or more ASICs, or the like. In addition, connection page module 402 may be combined across modules, or split to create even more functional modules. As those skilled in the art will realize, the scope of the invention is not limited to the illustrative embodiment of FIG. 4.

In another aspect of the invention, middleware component 301 may further provide security features. For example, trust may be provided such that spam is significantly reduced or eliminated. With the connection page 402, secure communications between an application and a content server, for example, may be significantly streamlined.

For example, connection page module 402 may obtain permission information and/or security keys via a bi-directional data network accessible by the mobile terminal device 112. Permission information might include encryption/decryption information for content received in encrypted formats.

In another aspect of the invention, middleware component 301 may provide for distribution of the connection page. For example, the middleware component 301 may provide for viral distribution such that when the connection page is available for sharing by one user is may be downloaded by another user who then in turn, makes the connection page available to others.

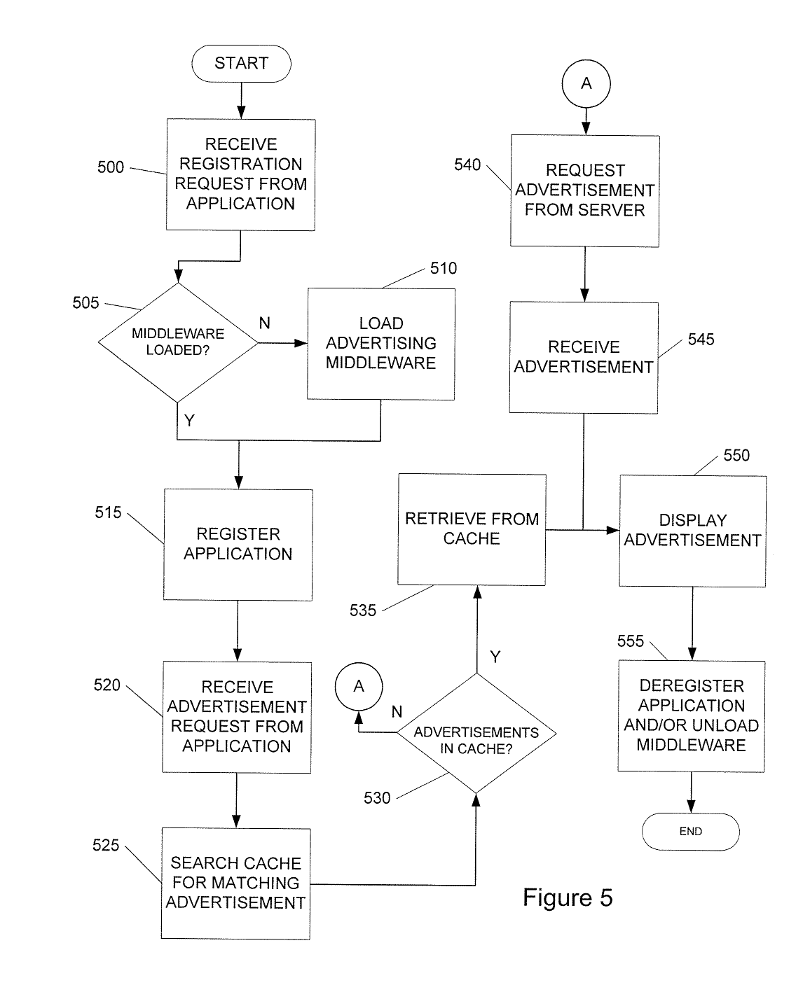

FIG. 5, describing one aspect of the invention, is a flowchart illustrating a method for providing relevant advertisements to a requesting application via a middleware component such as component 301 in FIGS. 3 and 4. In step 500, a registration request may be received from an application. An application may be aware of the middleware component based on, for example, system wide broadcasts or advertisements from the middleware component. In step 505, a determination is made as to whether the middleware component has been loaded. If the middleware component has not been loaded, then in step 510, the middleware component is initialized and loaded. In one or more arrangements, the middleware component may be configured to automatically load upon startup of the mobile terminal device or alternatively or additionally, may be built-in to the operating system. Thus, if the middleware component is already loaded when the registration request is made by the application, the middleware component may register the application in response in step 515.

For example, the requesting second application may be assigned a unique identifier to differentiate the requesting second application from other applications, e.g., the aforementioned first application. In step 520, the middleware component may receive a request for one or more advertisements, including values associated with a list of parameters such as type, duration, position, and interval from the application via a functional API. In step 525, the middleware component searches a cache for one or more advertisements in accordance with the parameters. In step 530, a determination is made as to whether the cache contains a relevant advertisement matching the specified parameters.

If the cache is empty or no advertisements are identified as fitting the parameters from the cache in step 530, the middleware component may then, in step 540, transmit a request for one or more advertisements to an advertising server via a transport mechanism such as HTTP. In step 545, one or more advertisements are received from the advertising server through the transport layer and stored in the cache. In step 550, the selected advertisements are displayed to the user according to, for example, the parameters received in step 520. Alternatively, if a relevant advertisement is available in the cache from step 530, the relevant advertisement is retrieved from the cache in step 535 and displayed in step 550. In step 555, the middleware component may receive a deregistration message from the second application if, for example, the application is being closed by a user. In one or more arrangements, if the middleware component is not being used by other application, the middleware component may be unloaded from memory. Where other application(s) are still registered or communicating with the middleware component, the middleware might not be unloaded. Alternatively, the middleware component may remain resident in memory until the mobile device is powered off.

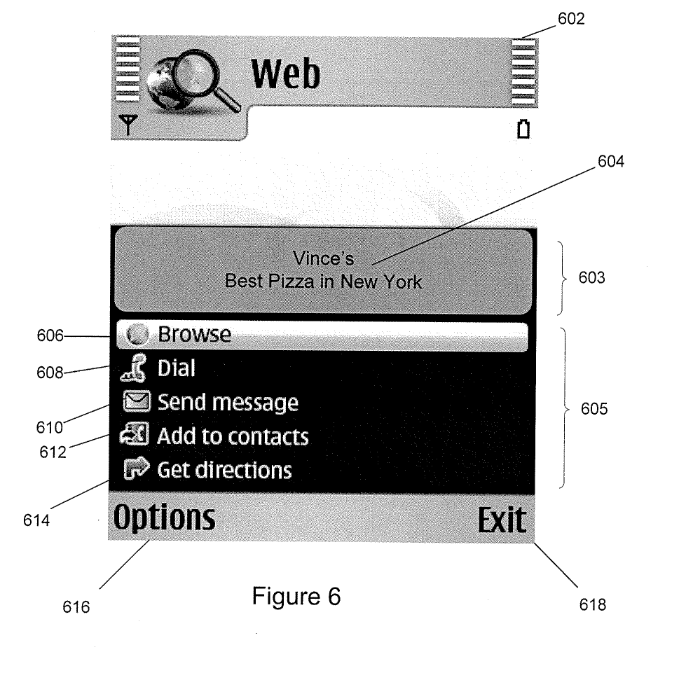

FIG. 6, describing one aspect of the invention, illustrates one embodiment of a connection page 602 produced by the connection page module 402 in accordance with an aspect of the invention. In FIG. 6, connection page 602 is displayed on the display of a mobile device. Connection page 602 may be an animated page which includes, for example, an advertisement view 603 to display advertisements 604. For example, connection page 602 includes an advertisement for a New York Pizza restaurant named “Vince's.” The types of advertisements used in connection page 602 may take various forms such as banner or ticker type advertisements. The advertisements may also include video and audio segments.

Connection page 602 may also include an action view 605 to display various other mobile device services such as Internet browsing services 606, mobile phone dialing service 608, send message service 610, add to contacts service 612, and get directions service 614. Those skilled in the art will realize that numerous other additional services supported by the mobile device may also be offered to the user. Additional features for each service may be displayed through selection of an options feature 616. Moreover, the connection page may be closed by selection of the “Exit” option 618. Additionally, the mobile device services may be related to, derived from, or initiated by an advertisement on the advertisement view 603.

A connection such as connection page 602 may also be used to present click-to-action commands, for example on the action view 605, that are available for a user, the commands such as 1) “Click-to-Call” which initiates a phone call to the advertiser selected phone number; 2) “Click-to-Browse” which initiates a browser session to the advertiser defined URL; 3) “Click-to-Save-To-Gallery” which downloads a file to the Gallery; 4) “Click-to-ARTS” providing a server configurable icon, name and URL; 5) “Click-to-Save” which saves the contact information provided by the advertiser to the contacts, favorites, notes and calendar database; 6) “Click-to-Send-To-Friend” which initiates sending information to friends via a send user interface screen; and 7) “Click-to-Stream” which initiates a media player session to the advertiser.

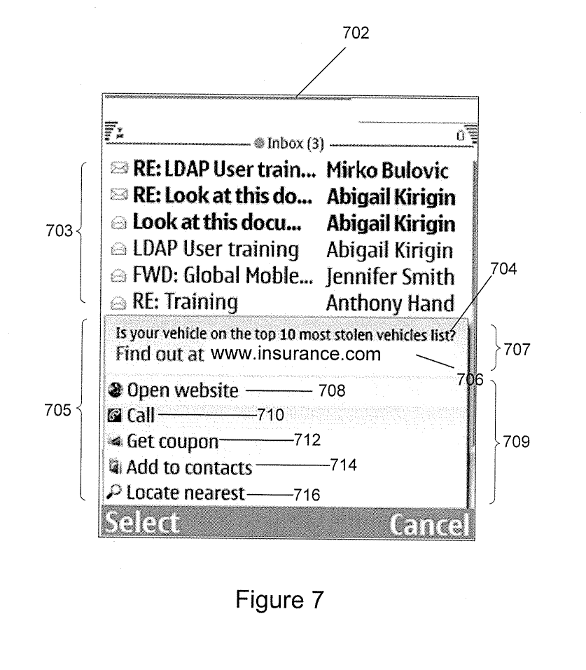

In another aspect of the invention, a user may interact with an advertisement. FIG. 7 illustrates a connection page 702 in which a user's messaging application, such as a SMS (Short Message System) application, a web mail or an e-mail, may be displayed in a first portion or a messaging view 703 on a display of the user device 112. A second portion or view 705, including e.g. an advertisement view 707 and an action view 709, on the display of the mobile device may be used to display advertising type information. For example, an advertisement may be presented which prompts a user to determine if they wish to view additional information regarding a particular subject. As shown if FIG. 7, a user may receive an advertisement which asks “Is your vehicle on the top ten most stolen vehicles list?” 704. Information regarding where to find the answer may also be provided such as through a website link such as “insurance.com” 706. Menu options related to the advertisement may be displayed directly adjacent, may be on the action view 709, to the advertisement so as to provide the user with easy access to information regarding the source of the advertisement. For example, actions such as “Open website” 708, “Call” 710, “Get coupon” 712, “Add to contacts” 714, and “Locate nearest” 716 may be provided.

In another aspect of the invention, advertising type information may be displayed on a connection page based on a user's geographical location. For example, with the use of GPS, the location of user may be determined so that information delivered to the user of the mobile device is based on user location. Such information may be presented in a second display portion 705 on user device 112.

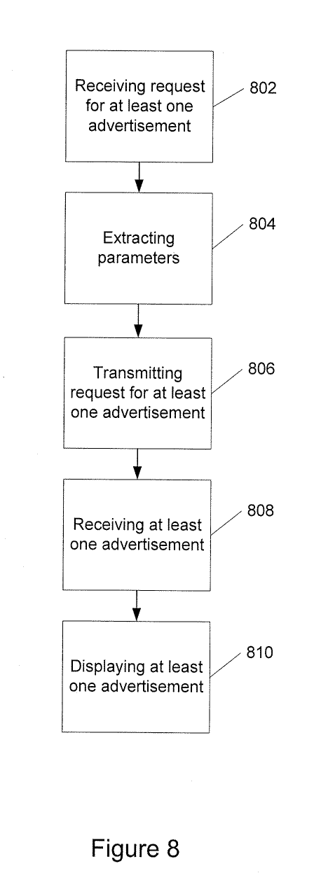

FIG. 8, describing one aspect of the invention, illustrates a flow chart of a method for providing relevant advertisements to a requesting application via a middleware component in accordance with an aspect of the invention. In FIG. 8, a middleware component receives a request for an advertisement in a step 802. In step 804, the middleware component may extract one for more parameters from the advertisement request. The parameters may include information such as format of advertising including full screen, banner, ticker; duration for displaying or playing advertisement; position and/or size of advertisement to be displayed; and interval for refreshing the advertisement or for providing new advertisements.

In step 806, a request for one or more advertisements based on the one or more extracted parameters is transmitted to an advertisement server in accordance with the one or more parameters. In step 808, one or more advertisements may be received at the middleware component from the advertisement server. The received one or more advertisements may be provided to the application. Finally, in step 810 the one or more advertisements may be displayed on the mobile device.

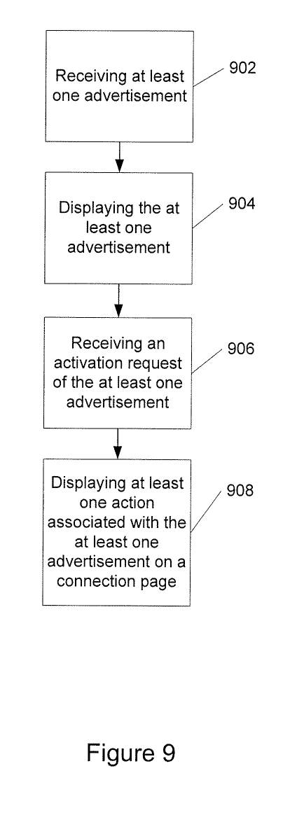

FIG. 9, describing another aspect of the invention, illustrates a flow chart of a method for displaying a connection page having an advertisement with click-to-action functionality. In step 902, at least one advertisement is received by a middleware component. The at least one advertisement may be displayed on an application in step 904. The middleware component may in step 906 receive an activation request of the displayed at least one advertisement. Based on the received activation request, actions associated with the at least one advertisement may be displayed on an connection page in step 908. The actions associated with the at least one advertisement may include click-to-action functions such as Click-to-Call” “Click-to-Browse,” “Click-to-Save-To-Gallery,” “Click-to-ARTS,” “Click-to-Save,” “Click-to-Send-To-Friend,” “Click-to-Stream” and other click-to-action functions. As those skilled in the art will realize, a user may choice to close the connection page without executing any click-to-action functions.

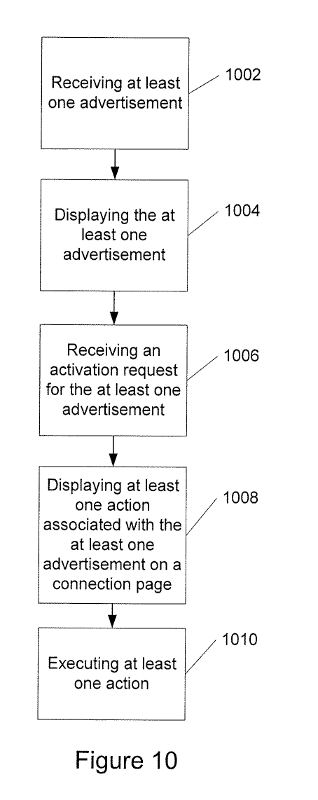

FIG. 10, describing another aspect of the invention, illustrates a flow chart of another method for displaying a connection page having an advertisement with click-to-action functionality. In step 1002, at least one advertisement may be received at an application. The at least one advertisement may be displayed in step 1004. At step 1006, an activation or selection of the at least one advertisement may be received. In step 1008, responsive to step 1006, actions associated with the at least one advertisement may be displayed on a connection page. The actions associated with the at least one advertisement may include click-to-action functions such functions such as Click-to-Call” “Click-to-Browse,” “Click-to-Save-To-Gallery,” “Click-to-ARTS,” “Click-to-Save,” “Click-to-Send-To-Friend,” “Click-to-Stream” and other click-to-action functions. In step 910, at least one action associated with the at least one advertisement may be executed.

The invention has been described in terms examples of embodiments thereof. Numerous other embodiments, modifications, combinations and variations within the scope and spirit of the appended claims will occur to persons of ordinary skill in the art from a review of this disclosure.

We claim:

1. A method, comprising:
receiving at least one advertisement;
displaying the at least one advertisement on an application;
receiving an activation request for the at least one advertisement displayed on the application; and
displaying at least one action associated with the activated at least one advertisement on a connection page of a user device.

2. The method of claim 1, further comprising executing the at least one action associated with the at least one advertisement.

3. The method of claim 2, wherein in response to executing the at least one action, receiving additional information pertaining to the least one advertisement.

3. The method of claim 1, further comprising storing the received at least one advertisement in a database.

4. The method of claim 1, wherein the at least one action comprises a click-to-action function.

5. The method of claim 1, wherein the at least one advertisement is selected based on geographical location of the user device.

6. The method of claim 5, wherein the geographical location is determined by a GPS application.

7. The method of claim 1, wherein the connection page includes an advertisement view for displaying the at least one advertisement.

8. The method of claim 1, wherein the connection page includes an action view for displaying the at least one action associated with the activated at least one advertisement.

9. A computer readable medium having computer-readable instructions for performing the steps comprising:
receiving an advertisement request from an application;
extracting at least one parameter from the advertisement request;
transmitting a request for at least one advertisement based on the at least one extracted parameter;
receiving the at least one requested advertisement;
providing the at least one advertisement to the application;
displaying the at least one advertisement on the application;
receiving an activation request for the at least one advertisement displayed on the application; and
displaying at least one action associated with the activated at least one advertisement on a connection page of a user device.

10. The computer readable medium of claim 9, further comprising executing the at least one action associated with the at least one advertisement.

11. The computer readable medium of claim 9, further comprising receiving a request for additional information in response to the displayed at least one advertisement.

12. The computer readable medium of claim 9, further comprising storing the at least one advertisement in a database.

13. The computer readable medium of claim 9, wherein the at least one action comprises a click-to-action function, the click-to-action function associated with the displayed at least one advertisement.

14. The computer readable medium of claim 9, further comprising receiving geographical location information of the user device.

15. The computer readable medium of claim 14, wherein the geographical location information is determined by a GPS application.

16. The computer readable media of claim 9, wherein the connection page includes an advertisement view and an action view.

17. A mobile terminal, comprising:
a display;
a transceiver;
a processor; and
a computer-readable medium having computer-readable instructions for performing steps comprising:
receiving a command from an application, the command including a request for at least one advertisement and one or more advertisement parameters;
receiving geographical location information;
identifying at least one advertisement based on the one or more advertisement parameters and the geographical location information;
displaying the at lease one advertisement on an application;
receiving an activation request for the at least one advertisement displayed on the application; and
displaying at least one action associated with the activated at least one advertisement on an connection page of the user device.

18. The mobile terminal of claim 17, wherein the at least one action comprises displaying a click-to-action function on the connection page, the click-to-action function associated with the displayed at least one advertisement.

19. The mobile terminal of claim 17, wherein the method further comprises receiving the requested at least one advertisement from an advertisement server.

20. The mobile terminal of claim 18, wherein the click-to-action function is displayed adjacent to the at least one advertisement on the connection page of the user device.

21. The mobile terminal of claim 17, further including execution the at least one action associated with the at least on advertisement.

22. The mobile terminal of claim 17, wherein the geographical location information is determined by a GPS application.
